(19) United States
(12) Patent Application Publication
(10) Pub. No.: US 2018/0257382 A1
(43) Pub. Date: Sep. 13, 2018

(54) LIQUID EJECTION APPARATUS AND LIQUID CONTAINER

(71) Applicant: SEIKO EPSON CORPORATION, Tokyo (JP)

(72) Inventors: Hiroyoshi OZEKI, Shiojiri-shi (JP); Takumi NAGASHIMA, Matsumoto-shi (JP); Tadahiro MIZUTANI, Shiojiri-shi (JP)

(73) Assignee: SEIKO EPSON CORPORATION, Tokyo (JP)

(21) Appl. No.: 15/912,046

(22) Filed: Mar. 5, 2018

(30) Foreign Application Priority Data
Mar. 10, 2017 (JP) 2017-045845

(51) Int. Cl. B41J 2/175

(52) U.S. Cl. CPC B41J 2/1752; B41J 2/19; B41J 2/17513; B41J 2/17509

(57) ABSTRACT

Provided is a technique that makes it possible to secure a large storage amount of ink, supply ink to a printer without exposing a tube to the outside of the case of the printer, and easily perform an operation of injecting ink. A liquid ejection apparatus includes a case, a paper-feeding tray, a liquid introduction portion, and a liquid container. The liquid container includes a liquid injection port, a reservoir that stores liquid, and a liquid supply port. The liquid injection port is provided at a position on the −Y direction side relative to the face on the −Y direction side of the case in a mounted state where the liquid container is mounted in the container mounting portion.

### CROSS REFERENCE TO RELATED APPLICATIONS

This application claims priority to Japanese Application No. 2017-045845 filed on Mar. 10, 2017. The entire disclosure of this Japanese application is expressly incorporated by reference herein.

### BACKGROUND

### 1. Technical Field

The present invention relates to a liquid ejection apparatus and a liquid container.

### 2. Related Art

JP-A-2005-96446, JP-A-2015-139882, and JP-A-2016-37018 disclose types of printers in which an ink cartridge or an ink pack is mounted. JP-A-2015-24605 and WO 2013/085023 disclose types of printers in which an ink liquid container and a recording head are connected via a tube.

JP-A-2005-96446, JP-A-2015-139882, JP-A-2016-37018, JP-A-2015-24605, and WO 2013/085023 are examples of related art.

In the printers described in JP-A-2005-96446, JP-A-2015-139882, and JP-A-2016-37018, the user replaces the cartridge or the pack when ink in the cartridge or the pack is used up. The amount of ink that can be stored in the cartridge or the pack is limited, and the replacement frequency tends to be high.

In the printers described in JP-A-2015-24605 and WO 2013/085023, the liquid container and the recording head are connected using the tube. Of such types of printers, in a type of printer to which a liquid container is installed externally to the printer, the liquid container and the case of the printer are separate, and thus there is a possibility that the tube will detach from the liquid container or the printer when the user unintentionally moves only the liquid container or the case of the printer. In addition, in such printers, the tube tends to be longer, and is exposed to the outside of the case of the printer, and thus there is a possibility that the tube will break. If the tube is detached or breaks, there is a possibility that the surrounding region will be contaminated with ink. In addition, out of types of printers in which a liquid container and a recording head are connected using a tube, in types of printers in which a liquid container is incorporated in the printer, the injection port of the liquid container needs to be exposed to the outside every time ink is to be injected into the liquid container, and thus an ink injection operation is complicated.

Therefore, there is demand for a technique that makes it possible to secure a large storage amount of ink, supply ink to the printer without exposing the tube to the outside of the case of the printer, and easily perform an operation of injecting ink. Such issues also apply to liquid containers that contain liquid other than ink, and other liquid ejection apparatuses that use such liquid containers.

### SUMMARY

(1) According to a first mode of the invention, a liquid ejection apparatus is provided. When three directions orthogonal to each other in a space are an X direction, a Y direction, and a Z direction, a direction along a gravity direction is the Z direction, a positive direction of the X direction is a +X direction and a negative direction of the X direction is a −X direction, a positive direction of the Y direction is a +Y direction and a negative direction of the Y direction is a −Y direction, and a positive direction of the Z direction is a +Z direction that is an upward gravity direction and a negative direction of the Z direction is a −Z direction that is a downward gravity direction, this liquid ejection apparatus has a case, a paper-feeding tray that is pulled out by being slid in the −Y direction relative to the case, and is mounted by being slid in the +Y direction, a container mounting portion provided on at least one of the +Z direction side and the −Z direction side of the paper-feeding tray, a liquid introduction portion provided at an end on the +Y direction side of the container mounting portion, and a liquid container that can be mounted to the container mounting portion by being slid in the +Y direction. In addition, the liquid container includes a liquid injection port, a reservoir that stores liquid injected from the liquid injection port, and a liquid supply port that is connected to the liquid introduction portion when the liquid container is mounted to the container mounting portion. A size in the Z direction of the liquid container is smaller than a size in the Y direction and a size in the X direction. In a mounted state where the liquid container is mounted in the container mounting portion, the liquid injection port is provided at a position on the −Y direction side relative to a face on the −Y direction side of the case.

With the liquid ejection apparatus of such a mode, it is possible to secure a large storage amount of liquid, supply liquid to the liquid ejection apparatus without exposing the tube to the outside of the case of the liquid ejection apparatus, and easily perform an operation of injecting liquid.

(2) In the liquid ejection apparatus of the above mode, the container mounting portion may include a first container mounting portion and a second container mounting portion provided on the −Z direction side relative to the first container mounting portion. When a liquid container mounted in the first container mounting portion is assumed to be a first liquid container, and a liquid container mounted in the second container mounting portion is assumed to be a second liquid container, in a mounted state where the liquid container is mounted in the container mounting portion, a position of a liquid injection port of the first liquid container and a position of a liquid injection port of the second liquid container may be different in at least one of the X direction and the Y direction. With the liquid ejection apparatus of such a mode, liquid can be easily injected into the first liquid container and the second liquid container.

(3) In the liquid ejection apparatus of the above mode, in a mounted state where the liquid container is mounted in the container mounting portion, the liquid injection port of the second liquid container may be positioned on the −Y direction side relative to the liquid injection port of the first liquid container. With the liquid ejection apparatus of such a mode, liquid can be easily injected into the first liquid container and the second liquid container.

(4) In the liquid ejection apparatus of the above mode, in a mounted state where the liquid container is mounted in the container mounting portion, the position of the liquid injection port of the first liquid container and the position of the liquid injection port of the second liquid container may be different in the X direction. With the liquid ejection apparatus of such a mode, liquid can be easily injected into the first liquid container and the second liquid container.

(5) In the liquid ejection apparatus of the above mode, in a mounted state where the liquid container is mounted in the container mounting portion, a bottom face of the reservoir may be inclined to be lower toward the liquid supply port in at least one of the X direction and the Y direction. With the liquid ejection apparatus of such a mode, it is possible to efficiently supply liquid from the liquid container to the liquid ejection apparatus.

(6) In the liquid ejection apparatus of the above mode, at least a portion of a face on the −Y direction side of the liquid container may transmit light. With the liquid ejection apparatus of such a mode, the amount of liquid in the liquid container can be easily checked.

(7) In the liquid ejection apparatus of the above mode, in a mounted state where the liquid container is mounted in the container mounting portion, the face on the −Y direction side of the liquid container may be positioned on the −Y direction side relative to the face on the −Y direction side of the case. With the liquid ejection apparatus of such a mode, the amount of liquid in the liquid container can be easily checked.

(8) According to a second mode of the invention, a liquid container is provided. When three directions orthogonal to each other in a space are an X direction, a Y direction, and a Z direction, a direction along a gravity direction is the Z direction, a positive direction of the X direction is a +X direction and a negative direction of the X direction is a −X direction, a positive direction of the Y direction is a +Y direction and a negative direction of the Y direction is a −Y direction, and a positive direction of the Z direction is a +Z direction that is an upward gravity direction and a negative direction of the Z direction is a −Z direction that is a downward gravity direction, the liquid container can be mounted, by being slid in the +Y direction, in a container mounting portion of a liquid ejection apparatus that includes a case, a paper-feeding tray that is pulled out by being slid in the −Y direction relative to the case, and is mounted by being slid in the +Y direction, the container mounting portion provided on at least one of the +Z direction side and the −Z direction side of the paper-feeding tray, and a liquid introduction portion provided at an end on the +Y direction side of the container mounting portion. This liquid container has a liquid injection port, a reservoir that stores liquid injected from the liquid injection port, and a liquid supply port that is connected to the liquid introduction portion when the liquid container is mounted in the container mounting portion. A size in the Z direction of the liquid container is smaller than a size in the Y direction and a size in the X direction, and in a mounted state where the liquid container is mounted in the container mounting portion, the liquid injection port is provided at a position protruding further on the −Y direction side than a face on the −Y direction side of the case.

With the liquid container of such a mode, it is possible to secure a large storage amount of liquid, supply liquid to the liquid ejection apparatus without exposing the tube to the outside of the case of the liquid ejection apparatus, and easily perform an operation of injecting liquid.

The invention can be realized in various modes in addition to the above modes as a liquid ejection apparatus and a liquid container. For example, the invention can be realized in a mode as a liquid ejection system that includes a liquid ejection apparatus and a liquid container.

### BRIEF DESCRIPTION OF THE DRAWINGS

The invention will be described with reference to the accompanying drawings, wherein like numbers reference like elements.

FIG. 1 is an explanatory diagram showing a schematic configuration of a liquid ejection apparatus in a first embodiment.

FIG. 2 is an explanatory diagram showing a schematic configuration of the liquid ejection apparatus in the first embodiment.

FIG. 3 is an explanatory diagram showing a schematic configuration of a liquid ejection apparatus in a second embodiment.

FIG. 4 is an explanatory diagram showing of a schematic configuration of a liquid ejection apparatus in a third embodiment.

FIG. 5 is an explanatory diagram showing a schematic configuration of a liquid ejection apparatus in a fourth embodiment.

FIG. 6 is an explanatory diagram showing a schematic configuration of a liquid ejection apparatus in a fifth embodiment.

FIG. 7 is an explanatory diagram showing a schematic configuration of a liquid ejection apparatus in a sixth embodiment.

FIG. 8 is an explanatory diagram showing a schematic configuration of the liquid ejection apparatus in the sixth embodiment.

### DESCRIPTION OF EXEMPLARY EMBODIMENTS

### A. First Embodiment

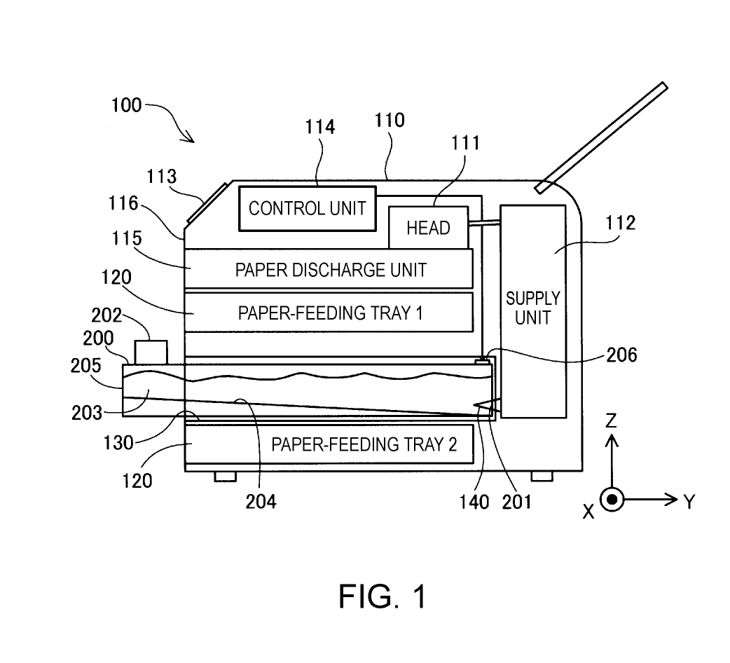

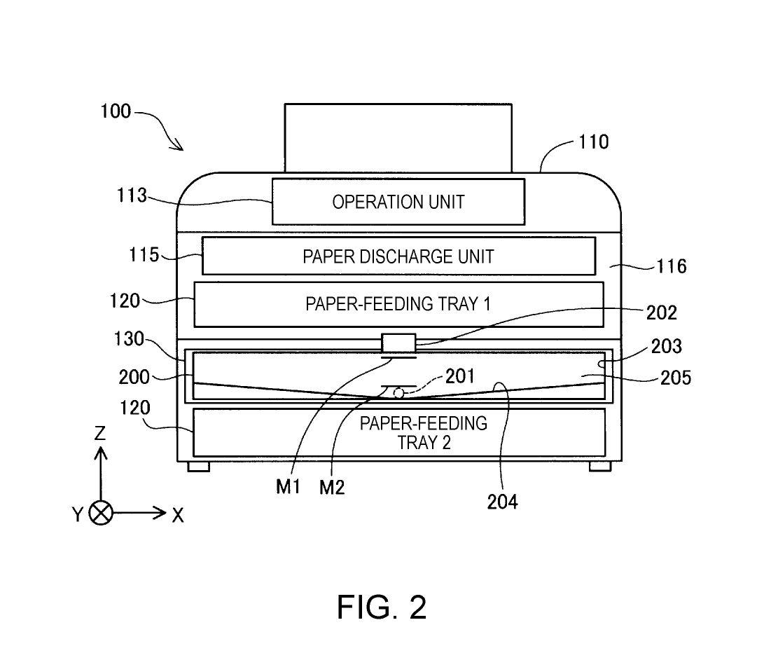

FIGS. 1 and 2 are explanatory diagrams showing a schematic configuration of a liquid ejection apparatus 100 in a first embodiment. FIG. 1 shows the arrangement of constituent elements when the liquid ejection apparatus 100 is viewed from the right side, and FIG. 2 shows the arrangement of the constituent elements when the liquid ejection apparatus 100 is viewed from the front side. In the drawings, three directions orthogonal to each other in a space (an X direction, a Y direction, and a Z direction) are shown. The X direction is the width direction of the liquid ejection apparatus 100, the Y direction is the depth direction of the liquid ejection apparatus 100, and the Z direction is the height direction of the liquid ejection apparatus 100. The Z direction is also a direction along the gravity direction. The positive direction of the X direction is a +X direction, the negative direction of the X direction is a −X direction, the positive direction of the Y direction is a +Y direction, the negative direction of the Y direction is a −Y direction, the positive direction of the Z direction is a +Z direction, and the negative direction of the Z direction is a −Z direction. The +Z direction is the upward gravity direction, and the −Z direction is the downward gravity direction. The +Y direction is the rearward direction of the liquid ejection apparatus 100, and the −Y direction is the forward direction of the liquid ejection apparatus 100. The +X direction is the right direction of the liquid ejection apparatus 100, and the −X direction is the left direction of the liquid ejection apparatus 100.

The liquid ejection apparatus 100 is an inkjet printer that performs printing by ejecting ink onto a recording medium. A liquid container 200 is mounted in the liquid ejection apparatus 100. The liquid container 200 stores ink as liquid.

The liquid ejection apparatus 100 has a case 110, paper-feeding trays 120, a container mounting portion 130, a liquid introduction portion 140, and the liquid container 200. Note that the liquid ejection apparatus 100 may have a configuration in which the liquid container 200 is omitted. Also, a combination of the liquid ejection apparatus 100 and the liquid container 200 can be referred to as a liquid ejection system.

The case 110 constitutes the outer shell of the liquid ejection apparatus 100. The case 110 has a recording head 111, a supply unit 112, an operation unit 113, a control unit 114, and a paper discharge unit 115.

The recording head 111 ejects ink supplied from the liquid container 200, onto a recording medium. The recording head 111 may be a serial head that reciprocally moves in the width direction (the X direction) of a recording medium, or may be a line head in which nozzles are arranged in the width direction (the X direction) of a recording medium. The supply unit 112 has the liquid introduction portion 140, and supplies, to the recording head 111, ink introduced from the liquid container 200 through the liquid introduction portion 140. The supply unit 112 includes various channels and pumps for supplying ink from the liquid introduction portion 140 to the recording head 111. The operation unit 113 accepts various operations for the liquid ejection apparatus 100, made by the user. The control unit 114 controls the overall operations of the liquid ejection apparatus 100 in accordance with an operation accepted by the operation unit 113. Openings for inserting the paper-feeding trays 120, an opening for inserting the liquid container 200, and an opening for discharging printing paper as a recording medium from the paper discharge unit 115 are provided in a face 116 (hereinafter, referred to as a “front face 116”) on the −Y direction side of the liquid ejection apparatus 100.

The paper-feeding trays 120 store printing paper as a recording medium. The paper-feeding trays 120 are pulled out by being slid in the −Y direction relative to the case 110, and are mounted by being slid in the +Y direction. The liquid ejection apparatus 100 of this embodiment has two paper-feeding trays 120 at different positions in the Z direction. Printing paper stored in the paper-feeding trays 120 is conveyed to immediately under the recording head 111 by a paper-feeding mechanism (not illustrated), and is discharged from the paper discharge unit 115 after printing is performed. Note that one paper-feeding tray 120 or three or more paper-feeding trays 120 may be provided in the liquid ejection apparatus 100.

The liquid container 200 is mounted to the container mounting portion 130 by being slid in the +Y direction. The container mounting portion 130 is provided on at least one of the +Z direction side and the −Z direction side of the paper-feeding trays 120. However, other constituent elements may be arranged between the container mounting portion 130 and the paper-feeding trays 120. In this embodiment, the container mounting portion 130 is provided on the −Z direction side of the paper-feeding tray 120 on the +Z direction side, and on the +Z direction side of the paper-feeding tray 120 on the −Z direction side. In other words, in this embodiment, the paper-feeding trays 120 are respectively arranged on both the +Z direction side and the −Z direction side of the container mounting portion 130.

The liquid introduction portion 140 is connected to a liquid supply port 201 of the liquid container 200, and introduces ink from the liquid container 200 to the supply unit 112. The liquid introduction portion 140 is provided at the end portion on the +Y direction side of the container mounting portion 130.

The liquid container 200 contains ink. In this embodiment, the liquid container 200 is configured as a rectangular parallelepiped box. The liquid container 200 is also referred to as a “tank 200”. The liquid container 200 can be mounted to the container mounting portion 130 by being slid in the +Y direction. The size in the Z direction of the liquid container 200 is smaller than the size in the Y direction and the size in the X direction. As shown in FIG. 2, the size in the X direction of the liquid container 200 of this embodiment is substantially equal to the size in the X direction of the paper-feeding tray 120. Therefore, a large amount of ink can be stored in the liquid container 200. In addition, in this embodiment, a face 205 (also referred to as a “front face 205”) on the −Y direction side of the liquid container 200 is positioned on the −Y direction side relative to the front face 116 of the case 110. Accordingly, in a state where the liquid container 200 is mounted in the container mounting portion 130 (hereinafter, simply referred to as a “mounted state”), the liquid container 200 protrudes from the case 110 on the −Y direction side. Therefore, the liquid container 200 can store more ink. The liquid container 200 has the liquid supply port 201, a liquid injection port 202, and a liquid reservoir 203.

The liquid introduction portion 140 (FIG. 1) provided in the container mounting portion 130 is inserted into the liquid supply port 201. The liquid supply port 201 is provided in the end portion on the +Y direction side of the liquid container 200.

The liquid injection port 202 is an opening for injecting ink into the liquid container 200. After ink has been injected, a cap for suppressing the evaporation of ink may be attached to the liquid injection port 202. The liquid injection port 202 is in communication with the liquid reservoir 203. As shown in FIG. 1, in a mounted state, the liquid injection port 202 is provided at a position on the −Y direction side relative to the front face 116 of the case 110. More specifically, in this embodiment, the liquid injection port 202 is provided at a position on the −Y direction side relative to the front face 116 of the case 110, in the face in the +Z direction of the liquid container 200 (the upper face).

The liquid reservoir 203 stores ink injected from the liquid injection port 202. The liquid supply port 201 is in communication with the liquid reservoir 203. When the liquid introduction portion 140 is inserted into the liquid supply port 201, ink is introduced to the supply unit 112 from the liquid reservoir 203 through the liquid supply port 201 and the liquid introduction portion 140.

The liquid container 200 of this embodiment has a storage apparatus 206 in the end portion on the +Y direction side of the face on the +Z direction side. The storage apparatus 206 stores information regarding the capacity and the color of ink, for example. When the liquid container 200 is mounted to the container mounting portion 130, the storage apparatus 206 comes into contact with an electrode provided on the container mounting portion 130 side via the contact portion of a terminal conductive to the storage apparatus 206, and is electrically connected to the control unit 114. The control unit 114 can read the above-described various types of information from this storage apparatus 206. Note that the storage apparatus 206 can be provided at any position in the liquid container 200. In addition, the terminal that is conductive to the storage apparatus 206 may be provided at another location in the liquid container 200 such as a location in the face on the +Y direction side or the face on the −Z direction side of the liquid container 200. For example, a configuration may be adopted in which the storage apparatus 206 and the terminal conductive to the storage apparatus 206 are implemented on a single substrate, and the substrate is fixed to an external face of the liquid container 200. Note that the liquid container 200 may be configured such that the storage apparatus 206 is not included.

In this embodiment, in a mounted state, a bottom face 204 of the liquid reservoir 203 is inclined to be lower toward the liquid supply port 201 in at least one of the X direction and the Y direction. More specifically, in this embodiment, the bottom face 204 is inclined to be lower toward the liquid supply port 201 in the Y direction. Furthermore, in this embodiment, as shown in FIG. 2, the liquid supply port 201 is positioned substantially at the center in the X direction of the liquid reservoir 203, and the bottom face 204 of the liquid reservoir 203 is inclined to be lower from the end portion in the +X direction and the end portion in the −X direction toward the liquid supply port 201. Therefore, ink can be efficiently supplied from the liquid container 200 to the liquid ejection apparatus 100. Note that the liquid container 200 may be configured such that the bottom face 204 of the liquid reservoir 203 is not inclined.

In this embodiment, the front face 205 of the liquid container 200 transmits light. Therefore, in this embodiment, the amount of ink in the liquid container 200 can be visually recognized from outside of the liquid container 200. Therefore, the amount of ink in the liquid container 200 can be easily checked. In addition, in this embodiment, in a mounted state, the front face 205 of the liquid container 200 is positioned on the −Y direction side relative to the front face 116 of the case 110, and thus the amount of ink in the liquid container 200 can be checked more easily. Note that the entirety or a portion of the front face 205 of the liquid container 200 may transmit light. In addition, the liquid container 200 may be configured such that the front face 205 does not transmit light.

Furthermore, in this embodiment, as shown in FIG. 2, an upper limit mark M1 indicating the upper limit amount of ink in the liquid container 200 is provided in the front face 205 of the liquid container 200. A lower limit mark M2 indicating the lower limit amount of ink in the liquid container 200 is also provided in the front face 205 of the liquid container 200. Therefore, in this embodiment, the amount of ink in the liquid container 200 can be easily checked from outside of the liquid container 200. Note that the liquid container 200 does not need to have both or one of the upper limit mark M1 and the lower limit mark M2.

Similar to the paper-feeding trays 120, in the liquid ejection apparatus 100 of this embodiment described above, the liquid container 200 is mounted to the case 110 by being slid in the Y direction, and thus a large storage amount of ink can be secured. Therefore, it is possible to reduce the frequency of replacing the liquid container 200 and the frequency of injecting ink. In addition, in the liquid ejection apparatus 100 of this embodiment, the liquid supply port 201 and the liquid introduction portion 140 are connected in the case 110 by mounting the liquid container 200 to the case 110. Therefore, it is possible to supply ink to the liquid ejection apparatus 100 without exposing the tube to the outside of the case 110 of the liquid ejection apparatus 100. Therefore, it is possible to suppress the leakage of ink due to the tube being detached or breaking, and contamination of the region around the tube. Furthermore, in this embodiment, the liquid injection port 202 of the liquid container 200 is provided at a position on the −Y direction side relative to the front face 116 of the case 110, and thus ink can be injected into the liquid container 200 without opening the cover of the case 110 or the like while the liquid container 200 is in a mounted state. Therefore, an operation of injecting ink can be performed easily.

### B. Second Embodiment

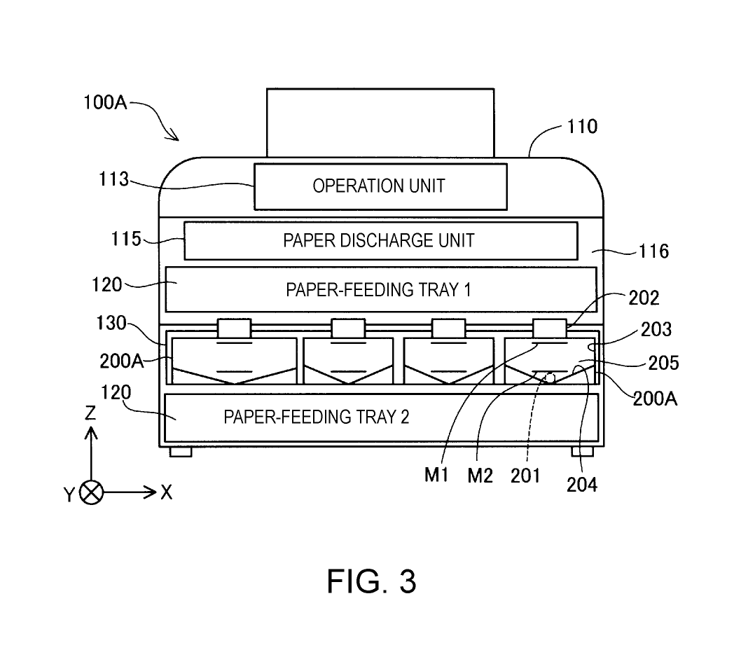

FIG. 3 is an explanatory diagram showing a schematic configuration of a liquid ejection apparatus 100A in a second embodiment. The liquid ejection apparatus 100A in the second embodiment is different from the first embodiment in the aspect of a liquid container, and is the same as the first embodiment in other respects. In the embodiments below, the same reference numerals are given to constituent elements that have the same function as those of the first embodiment, and detailed description thereof is omitted.

In the liquid ejection apparatus 100A of this embodiment, a plurality of liquid containers 200A are mounted in a case 110. In this embodiment, four liquid containers 200A are mounted in the case 110. The sizes in the X direction of the liquid containers 200A are different from that of the liquid container 200 in the first embodiment, but have the same configuration. For example, the liquid containers 200A store ink of different types or colors. The sizes in the X direction of the liquid containers 200A may be the same, or some or all of the sizes in the X direction of the liquid containers 200A may be different. A container mounting portion 130 may be provided in the case 110 for each of the liquid containers 200A, or may be configured to be able to accommodate a plurality of liquid containers 200A. Although not illustrated, in this embodiment, a supply unit 112 is provided with the same number of liquid introduction ports 140 as there are liquid containers 200A. The liquid introduction portions 140 are respectively connected to liquid supply ports 201 of the corresponding liquid containers 200A. Liquid injection ports 202 provided in the respective liquid containers 200A are all provided at positions on the −Y direction side relative to a front face 116 of the case 110.

Also according to the above-described liquid ejection apparatus 100A of the second embodiment, an effect similar to that of the liquid ejection apparatus 100 of the first embodiment is exerted. In this embodiment, a plurality of liquid containers 200A are mounted in the liquid ejection apparatus 100A, and thus an operation of injecting ink can be performed easily on the liquid containers 200A. Note that in the second embodiment, a configuration has been described in which the liquid containers 200A are separate, but these liquid containers 200A may be grouped in a single case.

### C. Third Embodiment

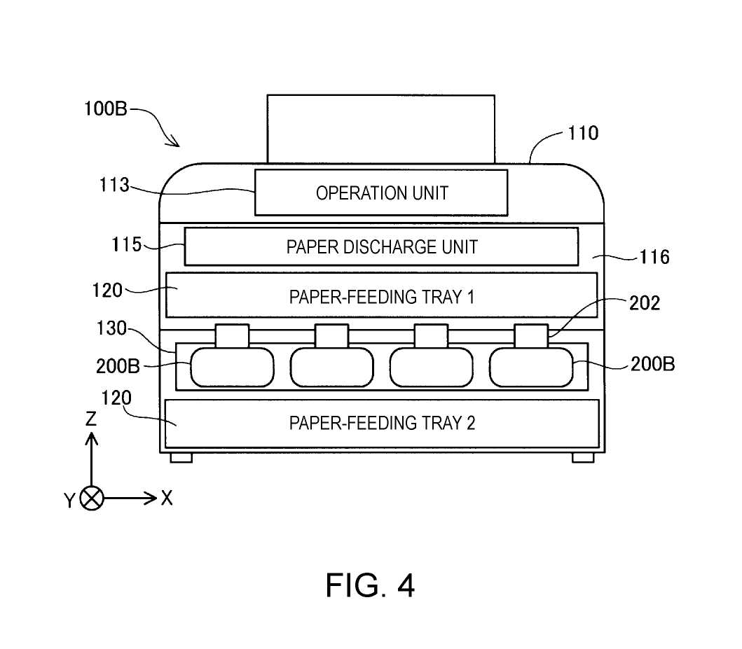

FIG. 4 is an explanatory diagram showing a schematic configuration of a liquid ejection apparatus 1006 in a third embodiment. The liquid ejection apparatus 1006 in the third embodiment is different from the second embodiment in the aspect of a liquid container that is mounted in a case 110, and is the same as the second embodiment in other respects.

Similarly to the second embodiment, in the liquid ejection apparatus 1006 of this embodiment, a plurality of liquid containers 200B are mounted in the case 110. However, in this embodiment, the liquid containers 200B that are mounted in the case 110 are configured as flexible packs. Note that also in this embodiment, liquid injection ports 202 provided in the liquid containers 200B are all provided at positions on the −Y direction side relative to a front face 116 of the case 110 of the liquid ejection apparatus 100.

Also according to the above-described liquid ejection apparatus 100B of the third embodiment, an effect similar to those of the first and second embodiments is exerted. Note that in this embodiment, the liquid containers 200B configured as packs may be mounted directly in a container mounting portion 130 by being slid, or may be mounted in the container mounting portion 130 by being slid in a state of being placed on a plate-like or box-like tray. Also, for example, a configuration may be adopted in which liquid containers described in the first embodiment, the second embodiment, and this embodiment onward, accommodate a pack described in this embodiment, and a liquid injection port 202 provided in the pack is exposed to the outside.

### D. Fourth Embodiment

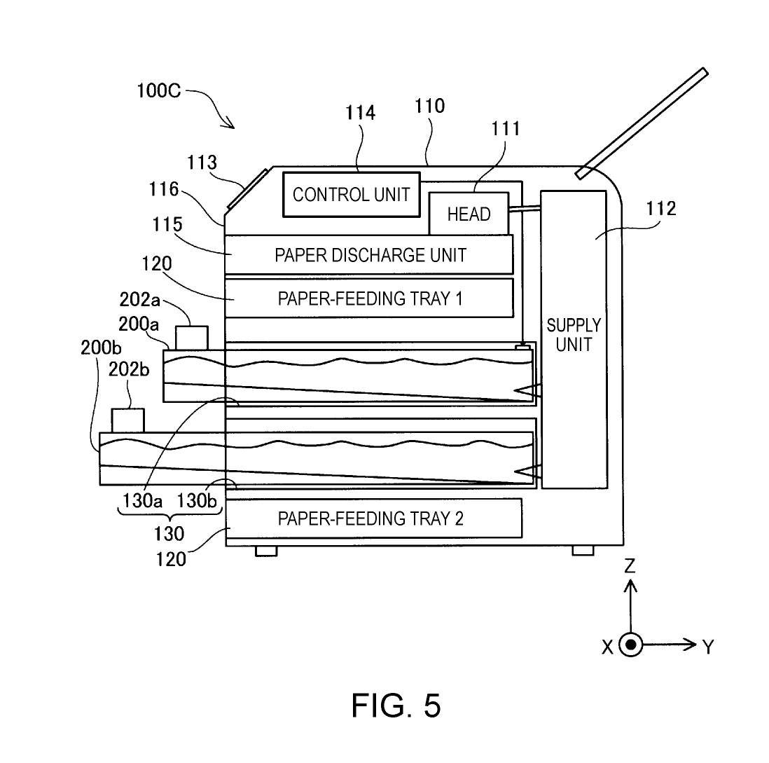

FIG. 5 is an explanatory diagram showing a schematic configuration of a liquid ejection apparatus 100C in a fourth embodiment. The liquid ejection apparatus 100C in the fourth embodiment is different from the first embodiment in the aspect of a liquid container that is mounted in a case 110 and the number of liquid containers, and is the same as the first embodiment in other respects.

In this embodiment, a container mounting portion 130 has a first container mounting portion 130a and a second container mounting portion 130b. The configurations of the first container mounting portion 130a and the second container mounting portion 130b are the same as the configuration of the container mounting portion 130 of the first embodiment. In the case 110, the second container mounting portion 130b is provided on the −Z direction side relative to the first container mounting portion 130a. A first liquid container 200a is mounted in the first container mounting portion 130a, and a second liquid container 200b is mounted in the second container mounting portion 130b.

In this embodiment, in a mounted state where the liquid containers 200a and 200b are respectively mounted in the container mounting portions 130a and 130b, the position of a liquid injection port 202a of the first liquid container 200a and the position of a liquid injection port 202b of the second liquid container 200b are shifted in the Y direction. Specifically, in a mounted state, the liquid injection port 202b of the second liquid container 200b is positioned further in the −Y direction relative to the liquid injection port 202a of the first liquid container 200a. Also, in this embodiment, in a mounted state, the face on the −Y direction side of the first liquid container 200a is positioned on the +Y direction side relative to the liquid injection port 202b of the second liquid container 200b. Accordingly, when the liquid ejection apparatus 100C is viewed from the +Z direction side, the liquid injection ports 202a and 202b of the liquid containers 200a and 200b are exposed in the +Z direction. Other configurations of the first liquid container 200a and the second liquid container 200b are the same as the liquid container 200 of the first embodiment.

Also according to the above-described liquid ejection apparatus 100C of the fourth embodiment, an effect similar to that of the first embodiment is exerted. In addition, according to this embodiment, the positions of the liquid injection ports 202a and 202b provided in the liquid containers 200a and 200b are shifted in the Y direction, and thus liquid can be easily injected into both the liquid containers 200a and 200b.

Note that in this embodiment, an example has been described in which two liquid containers 200 that respectively have liquid injection ports 202 provided at positions different in the Y direction are mounted at positions different in the Z direction, but three or more liquid containers 200 that respectively have liquid injection ports 202 provided at positions different in the Y direction may be mounted at positions different in the Z direction. In this case, it is preferable that the further a liquid container 200 is mounted in the −Z direction, the further the liquid injection port 202 of the liquid container 200 is provided on the −Y direction side, and it is preferable that, when the liquid ejection apparatus 100C is viewed from the +Z direction side, the liquid injection ports 202 of all of the liquid containers 200 are exposed in the +Z direction.

In addition, the configuration of this embodiment in which liquid containers are mounted at positions different in the Z direction can be applied to the second embodiment (FIG. 3) and the third embodiment (FIG. 4). Accordingly, in a configuration in which a plurality of liquid containers are aligned in the X direction, and furthermore, a plurality of liquid containers are aligned in the Z direction, the liquid injection port of the liquid container on the −Z direction side and the liquid injection port of the liquid container on the +Z direction side may be provided at positions different in the Y direction.

### E. Fifth Embodiment

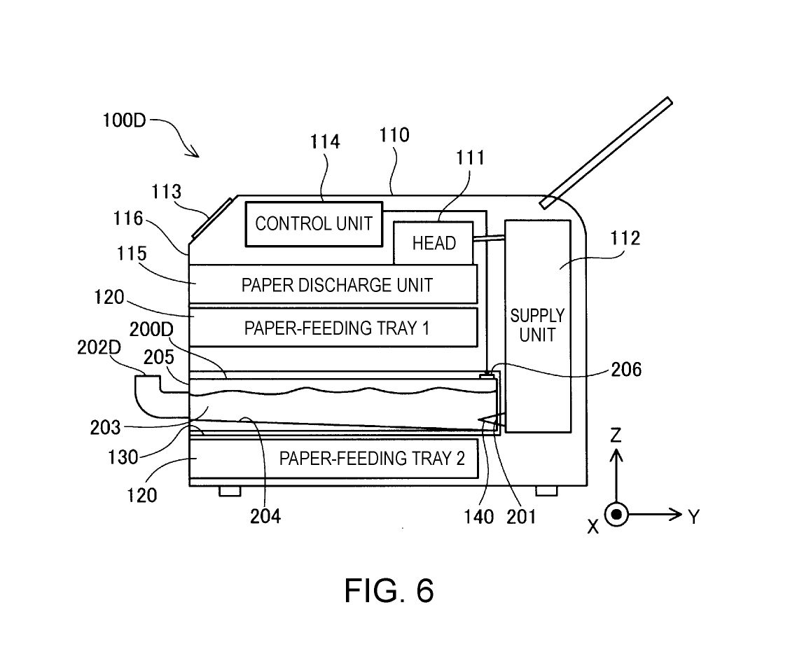

FIG. 6 is an explanatory diagram showing a schematic configuration of a liquid ejection apparatus 100D in a fifth embodiment. The liquid ejection apparatus 100D in the fifth embodiment is different from the first embodiment in the aspect of a liquid injection port, and is substantially the same as the first embodiment in other respects.

In the liquid ejection apparatus 100D of this embodiment, in a mounted state, a front face 205 of a liquid container 200D is configured substantially at the same position as a front face 116 of the case 110 in the Y direction. In addition, a liquid injection port 202D is provided in the front face 205 of the liquid container 200D, and the liquid injection port 202D is bent such that the opening of the liquid injection port 202D faces in the +Z direction.

Also according to the above fifth embodiment, the liquid injection port 202D is provided at a position on the −Y direction side relative to the front face 116 of the case 110, and thus an effect similar to that of the first embodiment is exerted. Note that in this embodiment, the liquid injection port 202D may transmit light. In addition, an upper limit mark M1 and a lower limit mark M2 may be provided in the liquid injection port 202D. Moreover, the aspect of the liquid injection port 202D of this embodiment may be applied to the liquid containers 200A, 200B, and 200C in the second embodiment (FIG. 3), the third embodiment (FIG. 4), and the fourth embodiment (FIG. 5).

### F. Sixth Embodiment

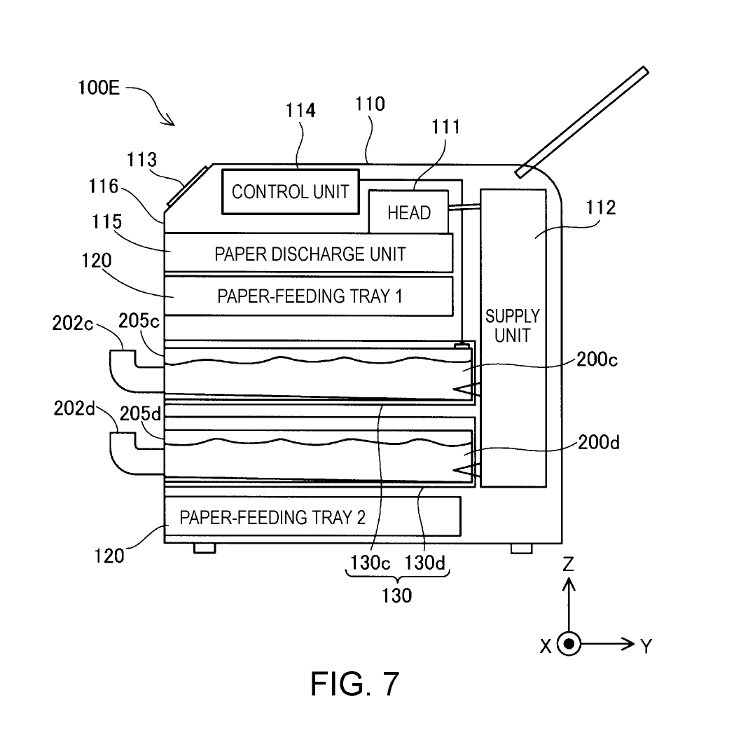

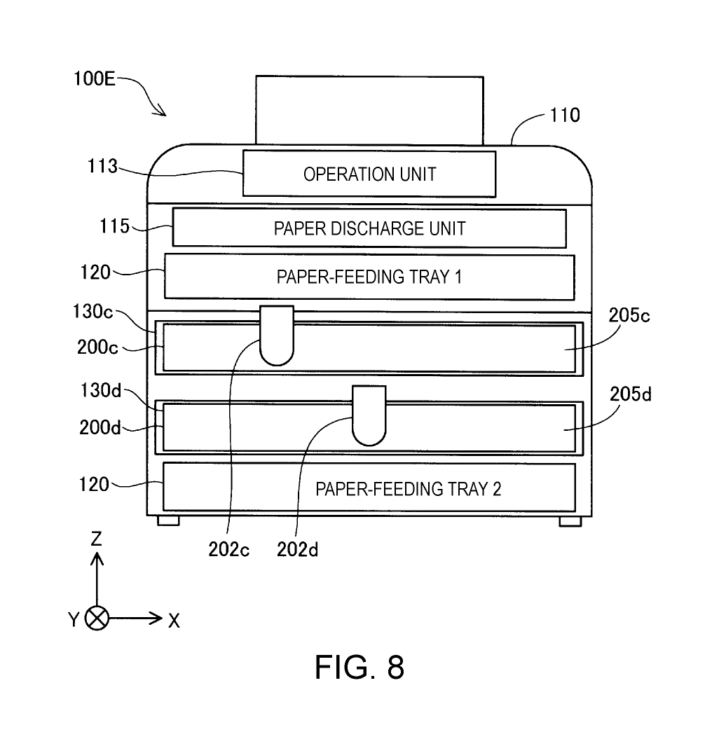

FIGS. 7 and 8 are explanatory diagrams showing a schematic configuration of a liquid ejection apparatus 100E in a sixth embodiment. Generally, the configuration of the liquid ejection apparatus 100E in the sixth embodiment is obtained by combining the configuration in the fourth embodiment (FIG. 5) and the configuration in the fifth embodiment (FIG. 6).

In this embodiment, similarly to the fourth embodiment, a container mounting portion 130 includes a first container mounting portion 130c and a second container mounting portion 130d. In a case 110, the second container mounting portion 130d is provided on the −Z direction side relative to the first container mounting portion 130c. A first liquid container 200c is mounted in the first container mounting portion 130c, and a second liquid container 200d is mounted in the second container mounting portion 130d. The configurations of the first liquid container 200c and the second liquid container 200d are the same as the configuration of the liquid container 200D of the fifth embodiment.

In this embodiment, in a mounted state where the liquid containers 200c and 200d are mounted in the container mounting portions 130c and 130d, a front face 205c of the first liquid container 200c and a front face 205d of the second liquid container 200d are substantially at the same position in the Y direction. In addition, the front face 205c of the first liquid container 200c and the front face 205d of the second liquid container 200d are substantially at the same position as a front face 116 of the case 110 in the Y direction.

In this embodiment, the first liquid container 200c and the second liquid container 200d respectively have liquid injection ports 202c and 202d with a configuration similar to that of the fifth embodiment. However, in this embodiment, as shown in FIG. 8, the liquid injection ports 202c and 202d are respectively provided in the front face 205c of the first liquid container 200c and the front face 205d of the second liquid container 200d such that the positions in the X direction of the liquid injection ports 202c and 202d are different from each other. According to this embodiment, an effect similar to those of the above embodiments is obtained, and the positions of the liquid injection ports 202c and 202d provided in the liquid containers 200c and 200d are shifted in the X direction, and thus liquid can be easily injected into both the liquid containers 200c and 200d.

Note that, in this embodiment, the positions of the liquid injection ports 202c and 202d in a mounted state are the same in the Y direction, but those positions may be different in the Y direction position. Accordingly, the positions of liquid injection ports may be different both in the X direction and the Y direction in a mounted state.

In addition, the configuration in this embodiment in which liquid injection ports are provided at positions different in the X direction can also be applied to the second embodiment (FIG. 3) and the third embodiment (FIG. 4). Specifically, in a configuration in which a plurality of liquid containers are aligned in the X direction, and furthermore, a plurality of liquid containers are aligned also in the Z direction, the liquid container on the −Z direction side and the liquid container on the +Z direction side may be provided with liquid injection ports at different positions in the X direction.

### G. Modified Example

The invention is not limited to a printer and a liquid container that stores ink for the printer, and can also be applied to any liquid ejection apparatuses that consume a liquid other than ink and liquid containers used for such liquid ejection apparatuses. For example, the invention can be applied as a liquid container used in the various following types of liquid ejection apparatuses.

(1) Image recording apparatuses such as a facsimile apparatus,

(2) Color material ejection recording apparatuses used to manufacture color filters for image display apparatuses such as a liquid crystal display,

(3) Electrode material ejection apparatuses used to form electrodes for organic EL (Electro Luminescence) displays, field emission displays (FED), or the like,

(4) Liquid consuming apparatuses that eject liquid containing biological organic matter used to manufacture biochips,

(5) Sample ejection apparatuses serving as precision pipettes,

(6) Lubricating oil ejection apparatuses,

(7) Resin solution ejection apparatuses,

(8) Liquid consuming apparatuses that perform pinpoint ejection of lubricating oil to precision machines such as a watch and a camera,

(9) Liquid consuming apparatuses that eject transparent resin solution such as UV-cured resin solution onto substrates in order to form micro-hemispherical lenses (optical lenses) or the like used in optical communication elements or the like,

(10) Liquid consuming apparatuses that eject acid or alkaline etchant in order to etch substrates or the like, and

(11) Liquid consuming apparatuses that include liquid consumption heads for discharging a very small amount of any other kinds of droplet.

Note that “droplet” refers to a state of the liquid discharged from liquid consuming recording apparatuses or liquid consuming apparatuses, and includes droplets having a granular shape, a tear-drop shape, and a shape with a thread-like trailing end. The “liquid” mentioned here need only be a material, the liquid state of which can be ejected by liquid consuming recording apparatuses or liquid consuming apparatuses. For example, the “liquid” need only be a material in a state where a substance is in a liquid phase, and a liquid material having a high or low viscosity, sol, gel water, and other liquid materials such as inorganic solvent, organic solvent, solution, liquid resin, and liquid metal (metallic melt) are also included as a “liquid”. Furthermore, the “liquid” is not limited to being a single-state substance, and also includes particles of a functional material made from solid matter, such as pigment or metal particles, that are dissolved, dispersed, or mixed in a solvent, or the like. Representative examples of the liquid include ink such as that described in the above embodiment, liquid crystal, or the like. Here, the “ink” encompasses general water-based ink and oil-based ink, as well as various types of liquid compositions such as gel ink and hot melt ink.

The invention is not limited to the above embodiment and modified examples, and can be achieved with various configurations without departing from the gist thereof. For example, the technical features in the embodiment and modified examples that correspond to the technical features in the modes described in the summary of the invention can be replaced or combined as appropriate in order to solve some or all of the problems described above, or in order to achieve some or all of the above-described effects. A technical feature that is not described as essential in the specification can be deleted as appropriate.

What is claimed is:

1. A liquid ejection apparatus, comprising:
when three directions orthogonal to each other in a space are an X direction, a Y direction, and a Z direction,
a direction along a gravity direction is the Z direction,
a positive direction of the X direction is a +X direction and a negative direction of the X direction is a −X direction,
a positive direction of the Y direction is a +Y direction and a negative direction of the Y direction is a −Y direction, and
a positive direction of the Z direction is a +Z direction that is an upward gravity direction and a negative direction of the Z direction is a −Z direction that is a downward gravity direction,
a case;
a paper-feeding tray that is pulled out by being slid in the −Y direction relative to the case, and is mounted by being slid in the +Y direction;
a container mounting portion provided on at least one of the +Z direction side and the −Z direction side of the paper-feeding tray;
a liquid introduction portion provided at an end on the +Y direction side of the container mounting portion; and
a liquid container that can be mounted to the container mounting portion by being slid in the +Y direction,
wherein the liquid container includes:
a liquid injection port,
a reservoir that stores liquid injected from the liquid injection port, and
a liquid supply port that is connected to the liquid introduction portion when the liquid container is mounted in the container mounting portion, and
a size in the Z direction of the liquid container is smaller than a size in the Y direction and a size in the X direction, and
in a mounted state where the liquid container is mounted in the container mounting portion, the liquid injection port is provided at a position on the −Y direction side relative to a face on the −Y direction side of the case.

2. The liquid ejection apparatus according to claim 1,
wherein the container mounting portion includes a first container mounting portion and a second container mounting portion provided on the −Z direction side relative to the first container mounting portion, and
when a liquid container mounted in the first container mounting portion is assumed to be a first liquid container, and
a liquid container mounted in the second container mounting portion is assumed to be a second liquid container,
in a mounted state where the liquid container is mounted in the container mounting portion, a position of a liquid injection port of the first liquid container and a position of a liquid injection port of the second liquid container are different in at least one of the X direction and the Y direction.

3. The liquid ejection apparatus according to claim 2,
wherein, in a mounted state where the liquid container is mounted in the container mounting portion, the liquid injection port of the second liquid container is positioned on the −Y direction side relative to the liquid injection port of the first liquid container.

4. The liquid ejection apparatus according to claim 2,
wherein, in a mounted state where the liquid container is mounted in the container mounting portion, the position of the liquid injection port of the first liquid container and the position of the liquid injection port of the second liquid container are different in the X direction.

5. The liquid ejection apparatus according to claim 1,
wherein, in a mounted state where the liquid container is mounted in the container mounting portion, a bottom face of the reservoir is inclined to be lower toward the liquid supply port in at least one of the X direction and the Y direction.

6. The liquid ejection apparatus according to claim 1,
wherein at least a portion of a face on the −Y direction side of the liquid container transmits light.

7. The liquid ejection apparatus according to claim 6,
wherein, in a mounted state where the liquid container is mounted in the container mounting portion, the face on the −Y direction side of the liquid container is positioned on the −Y direction side relative to the face on the −Y direction side of the case.

8. A liquid container that can be mounted in a container mounting portion of a liquid ejection apparatus that includes:
when three directions orthogonal to each other in a space are an X direction, a Y direction, and a Z direction,
a direction along a gravity direction is the Z direction,
a positive direction of the X direction is a +X direction and a negative direction of the X direction is a −X direction,
a positive direction of the Y direction is a +Y direction and a negative direction of the Y direction is a −Y direction, and
a positive direction of the Z direction is a +Z direction that is an upward gravity direction and a negative direction of the Z direction is a −Z direction that is a downward gravity direction,
a case,
a paper-feeding tray that is pulled out by being slid in the −Y direction relative to the case, and is mounted by being slid in the +Y direction,
the container mounting portion provided on at least one of the +Z direction side and the −Z direction side of the paper-feeding tray, and
a liquid introduction portion provided at an end on the +Y direction side of the container mounting portion,
wherein the liquid container can be mounted to the container mounting portion by being slid in the +Y direction,
the liquid container comprising:
a liquid injection port;
a reservoir that stores liquid injected from the liquid injection port; and
a liquid supply port that is connected to the liquid introduction portion when the liquid container is mounted in the container mounting portion, and
a size in the Z direction of the liquid container is smaller than a size in the Y direction and a size in the X direction, and
in a mounted state where the liquid container is mounted in the container mounting portion, the liquid injection port is provided at a position protruding further on the −Y direction side than a face on the −Y direction side of the case.
